(19) United States
(12) Patent Application Publication
(10) Pub. No.: US 2019/0135953 A1
(43) Pub. Date: May 9, 2019

(54) OLEFIN POLYMERISATION CATALYSTS

(71) Applicant: SCG CHEMICALS CO., LTD., Bangsue Bangkok (TH)

(72) Inventors: Dermot O'HARE, Oxford (GB); Jean-Charles BUFFET, Oxford (GB)

(21) Appl. No.: 16/309,695

(22) PCT Filed: Jun. 14, 2017
(86) PCT No.: PCT/GB2017/051725

§ 371 Date: Dec. 13, 2018

(30) Foreign Application Priority Data
Jun. 15, 2016 (GB) 1610457.2

(51) Int. Cl. C08F 10/02; C07F 17/00

(52) U.S. Cl. CPC C08F 10/02; C08F 2420/02; C07F 17/00

(57) ABSTRACT

Constrained geometry catalytic compounds are disclosed as well as catalytic compositions comprising the compounds supported on solid support materials. The compounds and compositions are useful as catalysts in the polymerisation and copolymerisation of alkanes.

The present invention relates to catalytic compounds. More particularly, the present invention relates to constrained geometry catalytic compounds, as well as catalytic compositions comprising the constrained geometry compounds associated with a support material. The present invention also relates to the use of catalytic compounds and compositions in the polymerisation of alkenes.

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

At the time of their conception, constrained geometry complexes (CGCs) represented one of the first major departures from metallocene-based catalysts. In structural terms, CGCs feature a π-bonded ligand linked to one of the other ligands on the same metal centre, in such a manner that the angle subtended by the centroid of the π-system and the other ligand from the metal centre is smaller than in comparable complexes wherein the π-bonded ligand and the other ligand are not linked. To date, research in the field of CGCs has centred around ansa-bridged cyclopentadienyl amido complexes, with such catalysts presently featuring heavily in the industrial preparation of CGC-derived polymers.

In spite of the advances made using ansa-bridged cyclopentadienyl amido-based complexes, there remains a need for CGCs having improved characteristics. In particular, there remains a need for CGCs having improved catalytic properties and/or GCGs suitable for preparing polymers having desirable characteristics. Such improved catalytic properties may include enhanced catalytic activity, better co-monomer incorporation and improved stability. Desirable polymer characteristics may include particular polymer molecular weights, polydispersities and melt indices.

The present invention was devised with the foregoing in mind.

### SUMMARY OF THE INVENTION

According to a first aspect of the present invention, there is provided a compound of formula (I) as defined herein.

According to a further aspect of the present invention, there is provided a composition comprising a compound of formula (I) as defined herein and:
i. a support material; and/or
ii. an activator.

According to a further aspect of the present invention, there is provided a use of a compound of formula (I) defined herein or composition as defined herein in the polymerisation of ethylene and optionally one or more (3-10C)alkene.

According to a further aspect of the present invention, there is provided a polymerisation process comprising the step of:
a) polymerising ethylene and optionally one or more (3-10C)alkene in the presence of a compound of formula (I) defined herein or a composition as defined herein.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “(3-10C)alkene” as used herein includes reference to any alkene having 3-10 carbon atoms that is capable of being copolymerised with ethylene. Straight and branching aliphatic alkenes are included (e.g. 1-hexene or 1-octene), as are alkenes comprising an aromatic moiety (e.g. styrene).

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “aryl(m-nC)alkyl” means an aryl group covalently attached to a (m-nC)alkylene group. Examples of aryl-(m-nC)alkyl groups include benzyl, phenylethyl, and the like.

The term “halogen” or “halo” as used herein includes reference to F, Cl, Br or I. In a particular, halogen may be F or Cl, of which Cl is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Compounds of the Invention

As described hereinbefore, the present invention provides a compound of formula (I) shown below:

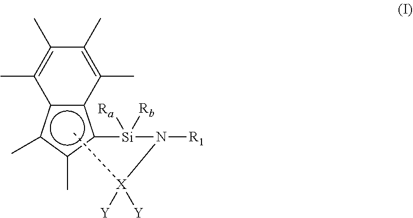

wherein
R₁ is (1-6C)alkyl, —Si(R₂)₃ or phenyl, either of which is optionally substituted with one or more groups selected from (1-4C)alkyl;
   wherein each R₂ is independently selected from (1-3C)alkyl;
Rₐ and R_{b} are independently hydrogen, (1-6C)alkyl, aryl and aryl(1-2C)alkyl, either or which may be optionally substituted with one or groups selected from (1-2C)alkyl;
X is scandium, yttrium, lutetium, titanium, zirconium or hafnium
each Y is independently halo, hydrogen, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or —Si[(1-4C)alkyl]₃;
   wherein Rₓ and R_{y} are independently (1-4C)alkyl.

The compounds of the invention offer a number of advantages when compared with CGCs currently favoured by industry. In particular, the compounds of the invention have been shown to be as much as twelve times more catalytically active in the homopolymerisation of ethylene than the ansa-bridged cyclopentadienyl amido CGC currently preferred in industry.

In an embodiment, R₁ is (1-5C)alkyl, —Si(R₂)₃ or phenyl, either of which is optionally substituted with one or more groups selected from (1-3C)alkyl, wherein each R₂ is independently selected from (1-4C)alkyl.

In another embodiment, R₁ is (1-5C)alkyl, —Si(R₂)₃ or phenyl, either of which is optionally substituted with one or more groups selected from (1-3C)alkyl, wherein each R₂ is independently selected from (1-3C)alkyl.

In another embodiment, R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, R₁ is (2-5C)alkyl, —Si(R₂)₃ or phenyl, either of which is optionally substituted with one or more (e.g. 2 or 3) groups selected from (1-3C)alkyl, wherein each R₂ is independently selected from (1-2C)alkyl.

In another embodiment, R₁ is (2-5C)alkyl or phenyl, either of which is optionally substituted with one or more (e.g. 2 or 3) groups selected from (1-4C)alkyl.

In another embodiment, R₁ is (2-5C)alkyl or phenyl, either of which is optionally substituted with one or more (e.g. 2 or 3) groups selected from (2-4C)alkyl.

In another embodiment, R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, R₁ is methyl, ethyl, iso-propyl, iso-butyl, sec-butyl, tert-butyl, neopentyl, trimethylsilyl, phenyl, mesityl, xylyl or di-isopropylphenyl.

In another embodiment, R₁ is (1-5C)alkyl.

In a particularly suitable embodiment, R₁ is n-butyl, tert-butyl, iso-propyl, or phenyl substituted with a (1-4C)alkyl group.

In a particularly suitable embodiment, R₁ is n-butyl, tert-butyl, iso-propyl, or phenyl substituted at the 4-position with a (1-4C)alkyl group.

In a particularly suitable embodiment, R₁ is n-butyl, tert-butyl, iso-propyl, or phenyl substituted at the 4-position with n-butyl or tert-butyl.

In a particularly suitable embodiment, R₁ is tert-butyl or iso-propyl.

In a particularly suitable embodiment, R₁ is tert-butyl.

In another embodiment, Rₐ and R_{b} are independently selected from hydrogen, (1-4C)alkyl, phenyl and benzyl.

In another embodiment, Rₐ and R_{b} are independently selected from hydrogen, (1-3C)alkyl, phenyl and benzyl.

In another embodiment, Rₐ and R_{b} are independently selected from hydrogen or (1-3C)alkyl.

In another embodiment, Rₐ and R_{b} are both methyl or ethyl, or one of Rₐ and R_{b} is methyl and the other is propyl.

In another embodiment, X is titanium, zirconium or hafnium. Suitably, X is zirconium or titanium. More suitably, X is titanium.

In another embodiment, each Y is independently halo, hydrogen, or a (1-4C)alkyl group which is optionally substituted with one or more groups selected from (1-4C)alkyl, halo, nitro, amino, phenyl and (1-4C)alkoxy.

In another embodiment, each Y is independently halo, hydrogen, or a (1-4C)alkyl group which is optionally substituted with one or more groups selected from (1-4C)alkyl, halo and phenyl.

In another embodiment, each Y is independently halo, hydrogen, or (1-4C)alkyl.

In another embodiment, each Y is independently halo. Suitably, at least one Y group is chloro. More suitably, both Y groups are chloro.

In an embodiment, the compound of formula (I) has a structure according to formula (Ia) below:

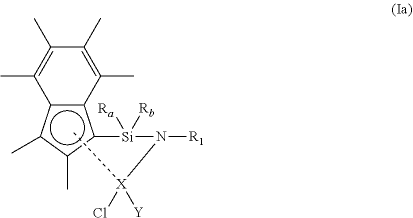

wherein

R₁, Rₐ, R_{b}, X and Y are each independently as defined in any of the paragraphs provided hereinbefore.

In another embodiment, the compound of formula (I) has a structure according to formula (Ia), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, the compound of formula (I) has a structure according to formula (Ia), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ia), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ia), wherein R₁ is n-butyl, tert-butyl, iso-propyl, or phenyl substituted with a (1-4C)alkyl group.

In another embodiment, the compound of formula (I) has a structure according to formula (Ia), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ia), wherein X is titanium or zirconium.

In another embodiment, the compound of formula (I) has a structure according to formula (Ia), wherein X is titanium.

In another embodiment, the compound of formula (I) has a structure according to formula (Ia), wherein each Y is independently halo, hydrogen, or (1-4C)alkyl.

In an embodiment, the compound of formula (I) has a structure according to formula (Ib) below:

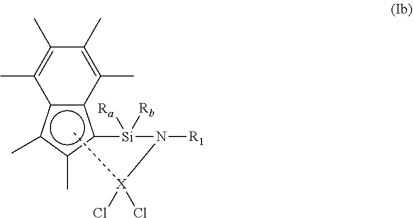

wherein

R₁, Rₐ, R_{b} and X are as defined in any of the paragraphs provided hereinbefore.

In another embodiment, the compound of formula (I) has a structure according to formula (Ib), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

In another embodiment, the compound of formula (I) has a structure according to formula (Ib), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ib), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ib), wherein R₁ is n-butyl, tert-butyl, iso-propyl, or phenyl substituted with a (1-4C)alkyl group.

In another embodiment, the compound of formula (I) has a structure according to formula (Ib), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ib), wherein X is titanium or zirconium.

In another embodiment, the compound of formula (I) has a structure according to formula (Ib), wherein X is titanium.

In an embodiment, the compound of formula (I) has a structure according to formula (Ic) below:

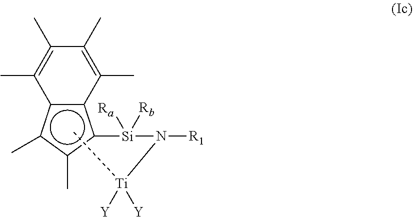

wherein

R₁, Rₐ, R_{b} and Y are each independently as defined in any of the paragraphs provided hereinbefore.

In another embodiment, the compound of formula (I) has a structure according to formula (Ic), wherein R₁ is (2-5C)alkyl, —Si(R₂)₃ or phenyl, either of which is optionally substituted with one or more (e.g. 2 or 3) groups selected from (1-4C)alkyl, wherein each R₂ is independently selected from (1-2C)alkyl.

n another embodiment, the compound of formula (I) has a structure according to formula (Ic), wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

In another embodiment, the compound of formula (I) has a structure according to formula (Ic), wherein R₁ is methyl, ethyl, iso-propyl, iso-butyl, sec-butyl, tert-butyl, neopentyl, trimethylsilyl, phenyl, mesityl, xylyl or di-isopropylphenyl. Suitably, R₁ is methyl, ethyl, iso-propyl, iso-butyl, sec-butyl, tert-butyl or neopentyl. Even more suitably, R₁ is tert-butyl.

In another embodiment, the compound of formula (I) has a structure according to formula (Ic), wherein R₁ is n-butyl, tert-butyl, iso-propyl, or phenyl substituted with a (1-4C)alkyl group.

In another embodiment, the compound of formula (I) has a structure according to formula (Ic), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Ic), wherein each Y is independently halo, hydrogen, or (1-4C)alkyl.

In another embodiment, the compound of formula (I) has a structure according to formula (Ic), wherein each Y is independently halo. Suitably, at least one Y group is chloro. More suitably, both Y groups are chloro.

In another embodiment, the compound of formula (I) has a structure according to formula (Ic), wherein at least one Y group is chloro and the other is (1-4C)alkyl.

In an embodiment, the compound of formula (I) has a structure according to formula (Id) below:

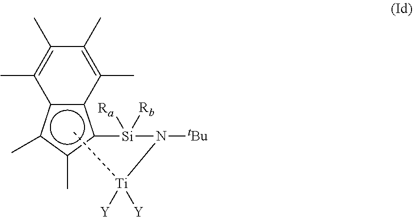

wherein

Rₐ, R_{b} and Y are each independently as defined in any of the paragraphs provided hereinbefore.

In another embodiment, the compound of formula (I) has a structure according to formula (Id), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In another embodiment, the compound of formula (I) has a structure according to formula (Id), each Y is independently halo, hydrogen, or (1-4C)alkyl.

In another embodiment, the compound of formula (I) has a structure according to formula (Id), wherein each Y is independently halo. Suitably, at least one Y group is chloro. More suitably, both Y groups are chloro.

In another embodiment, the compound of formula (I) has a structure according to formula (Id), wherein at least one Y group is chloro and the other is (1-4C)alkyl.

In an embodiment, the compound of formula (I) has a structure according to formula (Ie) below:

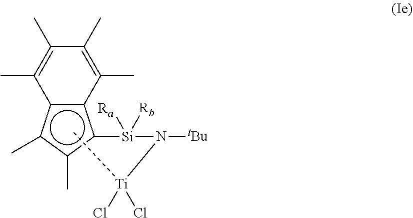

wherein

Rₐ and R_{b} are each independently as defined in any of the paragraphs provided hereinbefore.

In another embodiment, the compound of formula (I) has a structure according to formula (Ie), wherein Rₐ and R_{b} are independently selected from hydrogen or (1-3C)alkyl. Suitably, Rₐ and R_{b} are both methyl or ethyl, or one of Rₐ and R_{b} is methyl and the other is propyl.

In a particularly suitable embodiment, the compound of formula (I) has any of the following structures:

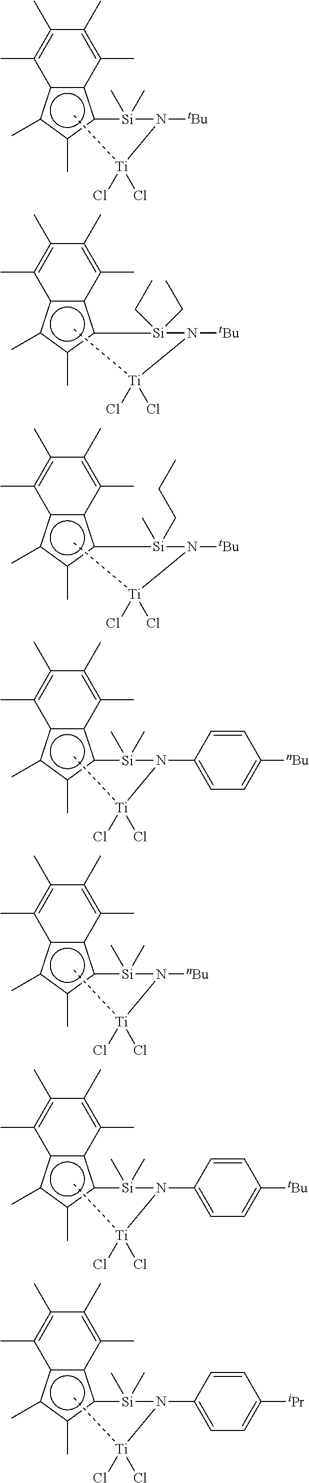

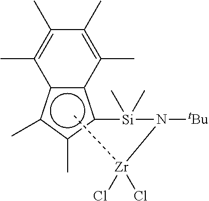

In a particularly suitable embodiment, the compound of formula (I) has any of the following structures:

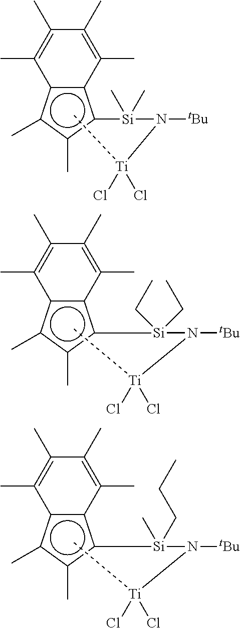

### Compositions of the Invention

As described hereinbefore, the present invention also provides a composition comprising a compound of formula (I) as defined herein and:
i. a support material; and/or
ii. an activator.

The compounds of the invention may be used in homogeneous, solution phase polymerisation reactions. When intended for use in homogeneous, solution phase polymerisation reactions, the compound of formula (I) may be used alongside an activator, such that the compound of formula (I) and the activator form a catalytic composition of the invention.

It will be appreciated that any suitable activator known in the art may be used. Activators may also be known in the art as co-catalysts. Suitable activators include organo aluminium compounds (e.g. alkyl aluminium compounds). Suitably, the activator is selected from aluminoxanes (e.g. methylaluminoxane (MAO)), triisobutylaluminium (TIBA), diethylaluminium (DEAC) and triethylaluminium (TEA). One or more activators may be used. The activator may also serve the purpose of scavenging moisture and/or oxygen.

The compounds of the invention may also be used in heterogeneous, slurry phase polymerisation reactions. When intended for use in homogeneous, solution phase polymerisation reactions, the compound of formula (I) is associated with a support material. The support material is insoluble under the polymerisation reaction conditions. The compound of the invention, when associated with a support material, forms a catalytic composition of the invention.

The compound of formula (I) may be associated with the support material by one or more ionic or covalent interactions. It will be understood that any minor structural modifications to the compound of formula (I) arising from it being associated with the support material are within the scope of this invention. For example, and without wishing to be bound by theory, the compound of formula (I) may be associated with the support material by one or more bonds from X to the surface of the support material (which may result in the loss of one or more Y groups).

In an embodiment, the support material is selected from silicas, layered-double hydroxides (LDH, e.g. AMO-LDH MgAl—CO₃, wherein “AMO” is an aqueous miscible organic solvent, a quantity of which is comprised within the LDH structure), and any other inorganic support material. Supports such as silica and AMO-LDH may be subjected to a heat treatment prior to use. An exemplary heat treatment involves heating the support to 400-600° C. (for silicas) or 100-150° C. (for AMO-LDHs) in a nitrogen atmosphere.

In another embodiment, the support material may be an activated support material. The support may be activated by the presence of a suitable activator being covalently bound to the support. Suitable activators include organo aluminium compounds (e.g. alkyl aluminium compounds), in particular methylaluminoxane. Examples of activated supports include methylaluminoxane activated silica and methylaluminoxane activated layered double hydroxide.

In another embodiment, the support material is an activated support material (e.g. MAO-activated silica), and the activator is selected from aluminoxanes (e.g. methylaluminoxane (MAO)), triisobutylaluminium (TIBA), diethylaluminium (DEAC) and triethylaluminium (TEA).

In an embodiment, the mole ratio of solid support to the compound of formula (I) is 50:1 to 500:1. Suitably, the mole ratio of solid support to the compound of formula (I) is 75:1 to 400:1. More suitably, the mole ratio of solid support to the compound of formula (I) is 100:1 to 300:1.

### Preparation of Compounds of Invention

The compounds of formula (I) may be synthesised by any suitable process known in the art. Particular examples of processes for the preparation compounds of the present invention are set out in the accompanying examples.

Suitably, a compound of the present invention is prepared by:
(i) reacting a compound of formula A:

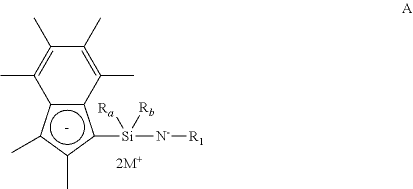

(wherein R_{1,} Rₐ and R_{b} are each as defined hereinbefore and M is Li, Na or K) with a compound of the formula B:

X(Y′)₄

### B

(wherein X is as defined hereinbefore and Y′ is halo (particularly chloro or bromo)) in the presence of a suitable solvent to form a compound of formula (I′):

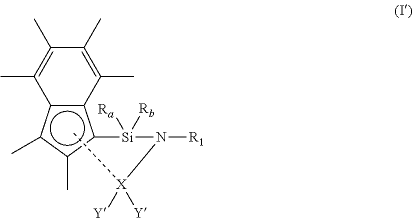

and optionally thereafter:
(ii) reacting the compound of formula Ia above with MY″ (wherein M is as defined above and Y″ is a group Y as defined herein other than halo), in the presence of a suitable solvent to form the compound of the formula (I″) shown below

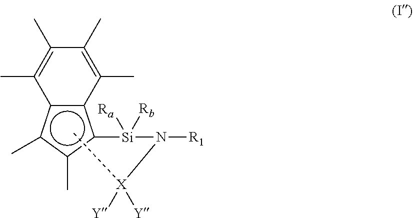

Suitably, M is Li in step (i) of the process defined above.

Suitably, the compound of formula B is provided as a solvate. In particular, the compound of formula B may be provided as X(Y)₄.THFₚ, where p is an integer (e.g. 2).

Any suitable solvent may be used for step (i) of the process defined above. A particularly suitable solvent is toluene or THF.

If a compound of formula (I) in which Y is other than halo is required, then the compound of formula (I′) above may be further reacted in the manner defined in step (ii) to provide a compound of formula (I″).

Any suitable solvent may be used for step (ii) of the process defined above. A suitable solvent may be, for example, diethyl ether, toluene, THF, dichloromethane, chloroform, hexane DMF, benzene etc.

Compounds of formula A may generally be prepared by:
(i) Reacting a compound of formula C:

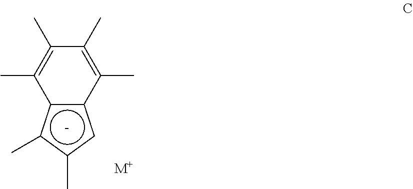

(wherein M is lithium, sodium, or potassium) with one equivalent of a compound having formula D shown below:

Si(Rₐ)(R_{b})(Cl)₂

### D

(wherein Rₐ and R_{b} are as defined hereinbefore)
to form the compound of the formula E shown below:

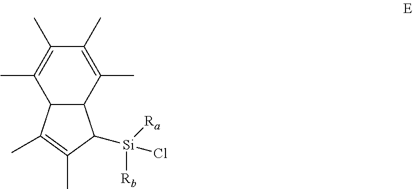

(ii) Reacting the compound of formula E with a compound of formula F shown below:

R₁—N(H)Li

### F

(wherein R₁ is as defined hereinbefore, and wherein Li may be substituted for K or Na).

Compounds of formulae A and F can be readily synthesised by techniques well known in the art.

Any suitable solvent may be used for step (i) of the above process. A particularly suitable solvent is THF.

Similarly, any suitable solvent may be used for step (ii) of the above process. A suitable solvent may be, for example, toluene, THF, DMF etc.

A person of skill in the art will be able to select suitable reaction conditions (e.g. temperature, pressures, reaction times, agitation etc.) for such a synthesis.

Once prepared, the compound of formula (I) may be associated with a support material by any suitable means known in the art. For example, the compound of formula (I) may be associated with a support material (e.g. SiO₂, MAO-activated SiO₂ (SSMAO) or MAO-activated LDH (LDHMAO)) by contacting the compound of formula (I) with the support material in a suitable solvent (e.g. toluene) with optional heating, and then isolating the resulting solid.

### Uses of the Compounds and Compositions

As described hereinbefore, the present invention also provides a use of a compound of formula (I) defined herein or a composition as defined herein in the polymerisation of ethylene and optionally one or more (3-10C)alkene.

The compounds and compositions of the invention may be used as catalysts in the preparation of a variety of polymers, including polyalkylenes (e.g. polyethylene) of varying molecular weight, and copolymers. Such polymers and copolymers may be prepared by homogeneous solution-phase polymerisation of a monomer-containing feed stream (e.g. using the compounds of the invention), or heterogeneous slurry-phase polymerisation of a monomer-containing feed stream (e.g. using the compositions of the invention).

In an embodiment, when the optional one or more (3-10C)alkene is not included, the compounds and compositions of the invention may be used to prepare polyethylene homopolymers. Suitably, the one or more (3-10C)alkene is an α-olefin.

In another embodiment, the optional one or more (3-10C)alkene is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the compounds and compositions of the present invention are useful as catalysts in the preparation of copolymers such as poly(ethylene-co-hexene), poly(ethylene-co-octene) and poly(ethylene-co-styrene).

In a particularly suitable embodiment, the compounds and compositions of the invention are used to copolymerise ethylene and styrene.

In a particularly suitable embodiment, the compounds and compositions of the invention are used to copolymerise ethylene and 1-hexene.

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1.

As described hereinbefore, the present invention also provides a polymerisation process comprising the step of:
a) polymerising ethylene and optionally one or more (3-10C)alkene in the presence of a compound of formula (I) defined herein or composition as defined herein.

The compounds and compositions of the invention may be used as catalysts in the preparation of a variety of polymers, including polyalkylenes (e.g. polyethylene) of varying molecular weight, and copolymers. Such polymers and copolymers may be prepared by homogeneous solution-phase polymerisation of a monomer-containing feed stream (e.g. using the compounds of the invention), or heterogeneous slurry-phase polymerisation of a monomer-containing feed stream (e.g. using the compositions of the invention).

In an embodiment, step a) is conducted at a temperature of 30-120° C. Suitably, step a) is conducted at a temperature of 40-80° C.

In another embodiment, step a) is conducted at a pressure of 1-10 bar.

In another embodiment, step a) is conducted in a suitable solvent (e.g. aromatics, including toluene, and/or alkanes, including hexanes or heptane).

In another embodiment, step a) may be conducted for between 1 minute and 5 hours. Suitably, step a) may be conducted for between 5 minutes and 2 hours.

In another embodiment, when the optional one or more (3-10C)alkene is not included, the process yields polyethylene homopolymer.

In another embodiment, the optional one or more (3-10C)alkene (which may be an α-olefin) is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the process may be used to prepare copolymers such as poly(ethylene-co-hexene), poly(ethylene-co-octene) and poly(ethylene-co-styrene).

In a particularly suitable embodiment, step a) comprises polymerising ethylene and styrene in the presence of a compound of formula (I) defined herein or composition as defined herein.

In a particularly suitable embodiment, step a) comprises polymerising ethylene and 1-hexene in the presence of a compound of formula (I) defined herein or composition as defined herein

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1.

### EXAMPLES

Particular examples of the invention will now be described, for the purpose of illustration only, with reference to the accompanying figures, in which:

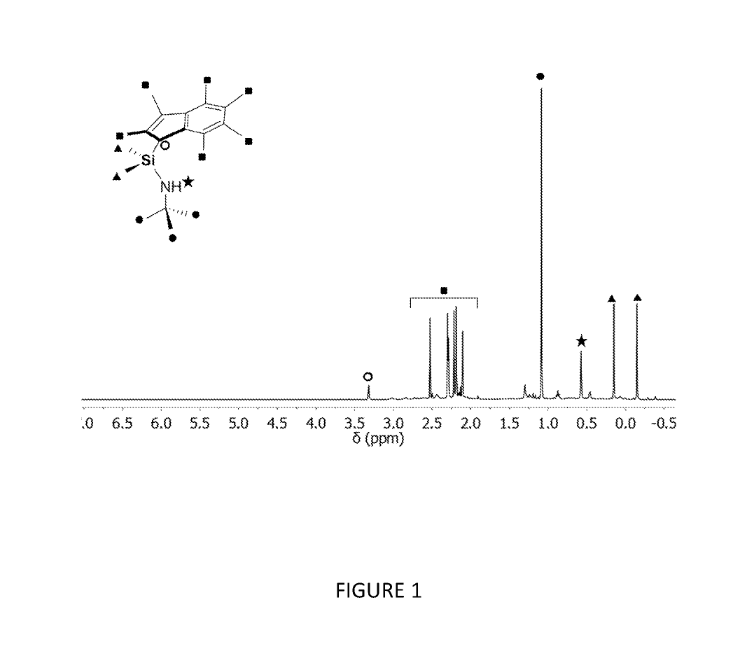

FIG. 1 shows the ¹H NMR spectrum (400 MHz, benzene-d₆, 23° C.) of ^{Me2}SB(^{tBu}N,I*)H₂.

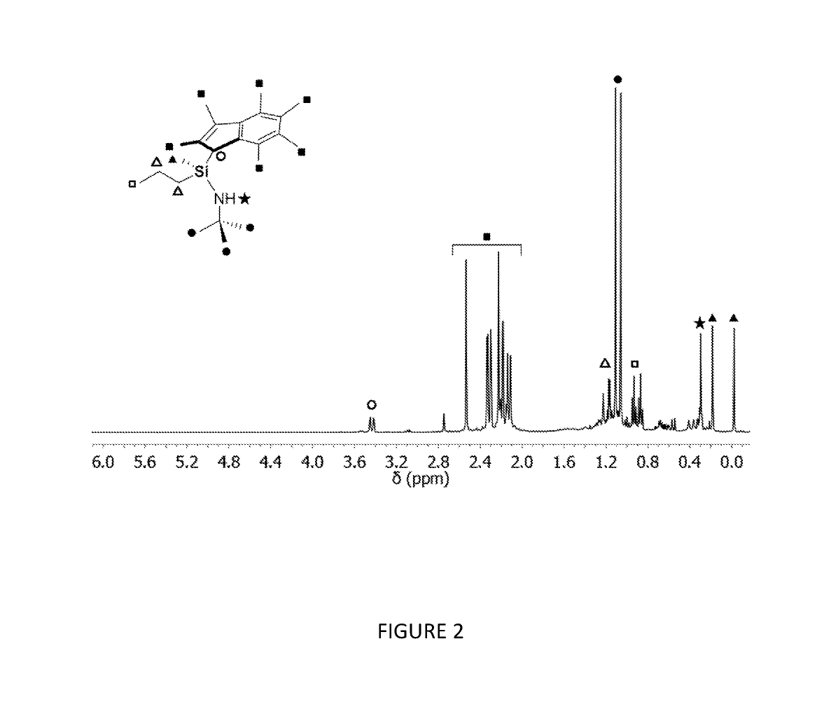

FIG. 2 shows the ¹H NMR spectrum (400 MHz, benzene-d₆, 23° C.) of ^{Me,Propyl}SB(^{tBu}N,I*)H₂.

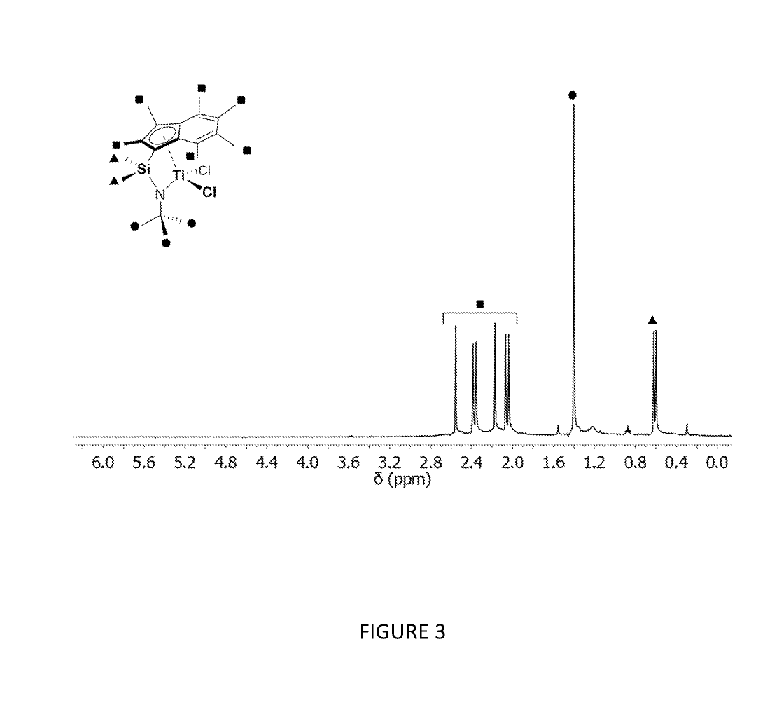

FIG. 3 shows the ¹H NMR spectrum (400 MHz, benzene-d₆, 23° C.) of ^{Me2}SB(^{tBu}N,I*)TiCl₂.

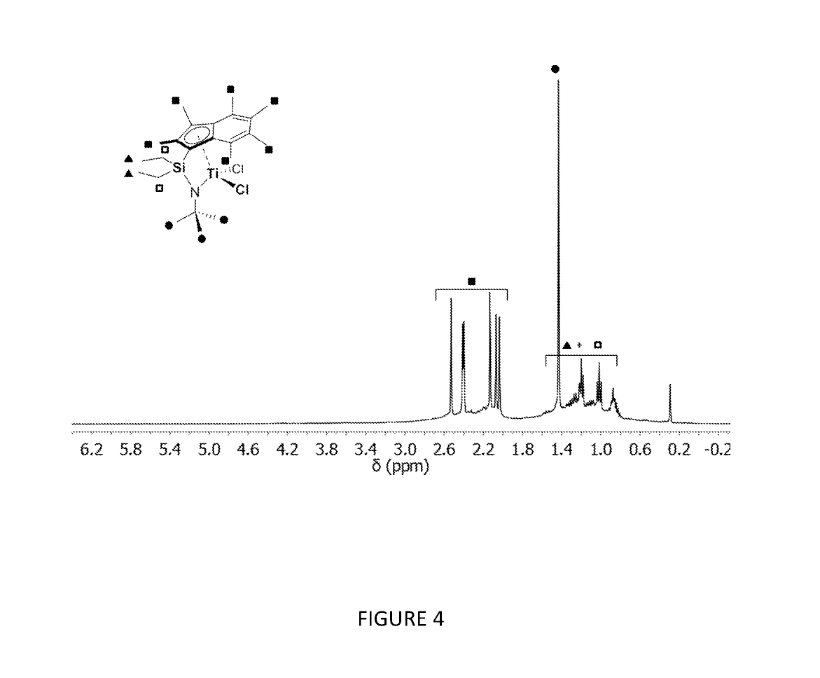

FIG. 4 shows the ¹H NMR spectrum (400 MHz, benzene-d₆, 23° C.) of ^{Et2}SB(^{tBu}N,I*)TiCl₂.

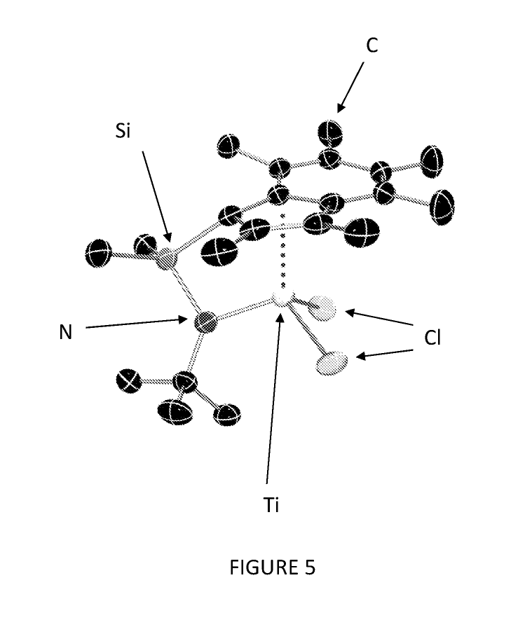

FIG. 5 shows the molecular structure of ^{Me2}SB(^{tBu}N,I*)TiCl₂.

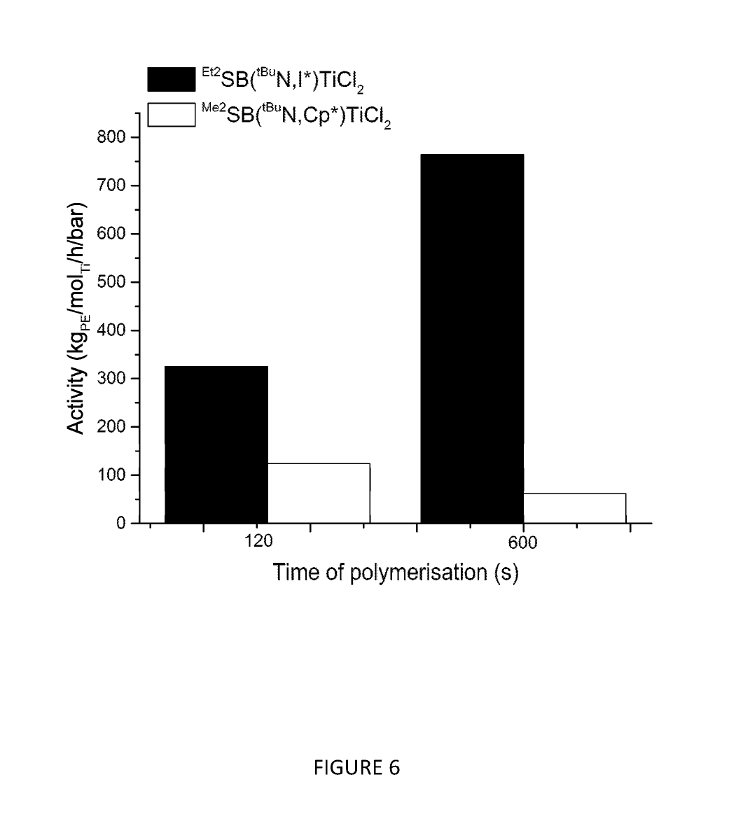

FIG. 6 compares the catalytic activity of the ^{Et}^{₂}SB(^{t}^{_{Bu}}N,I*)TiCl₂ constrained geometry compound of the invention with that of the ^{Me}^{₂}SB(^{t}^{_{Bu}}N,Cp*)TiCl₂ comparator compound when used in the solution phase polymerisation of ethylene. Polymerisation conditions: 2 bar ethylene, 50 mL hexanes, 40 mg MAO.

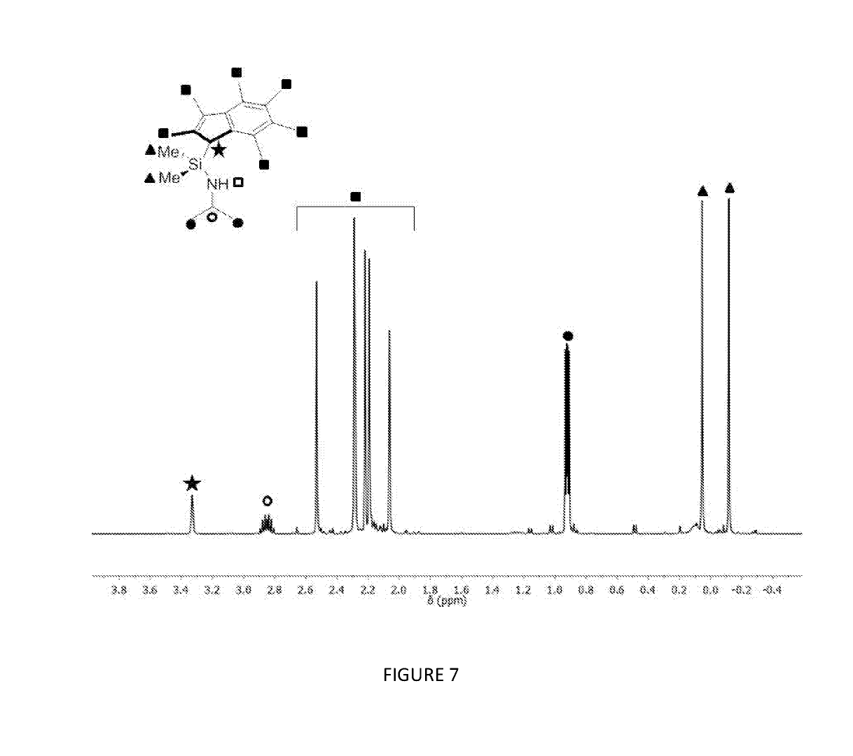

FIG. 7 shows the ¹H NMR spectrum (400 MHz, benzene-d₆, 23° C.) of ^{Me2}SB(^{iPr}N,I*)H₂.

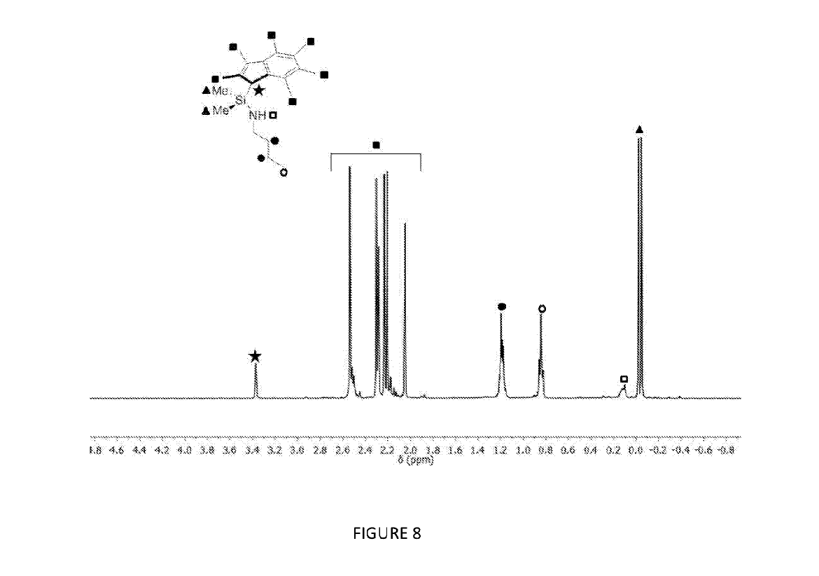

FIG. 8 shows the ¹H NMR spectrum (400 MHz, benzene-d₆, 23° C.) of ^{Me2}SB(^{nBu}N,I*)H₂.

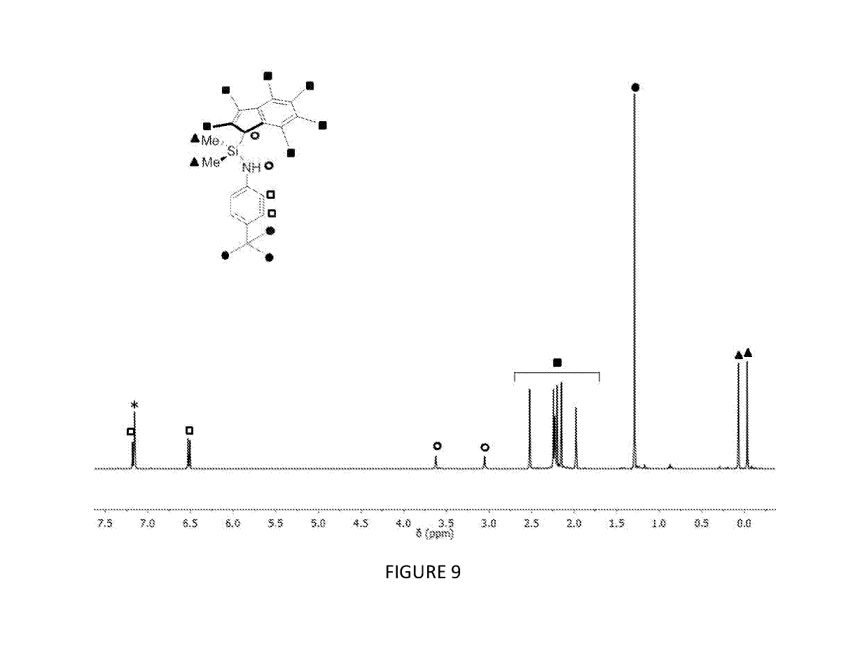

FIG. 9 shows the ¹H NMR spectrum (400 MHz, benzene-d₆, 23° C.) of ^{Me2}SB(^{4tBuPh}N,I*)H₂.

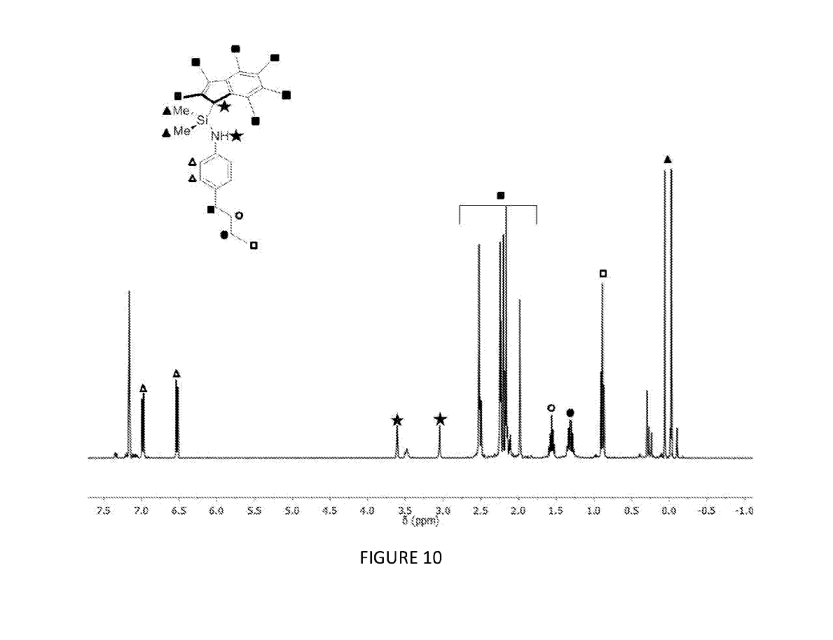

FIG. 10 shows the ¹H NMR spectrum (400 MHz, benzene-d₆, 23° C.) of ^{Me2}SB(^{4nBuPh}N,I*)H₂.

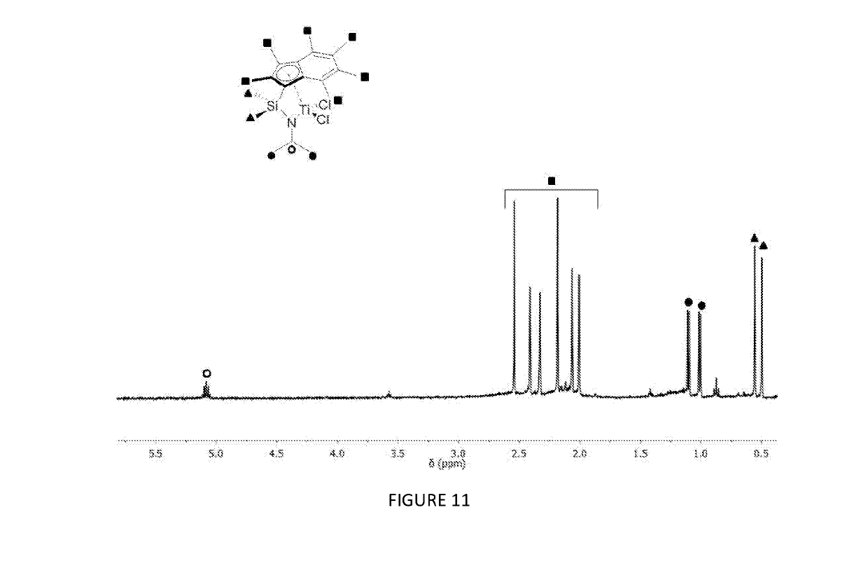

FIG. 11 shows the ¹H NMR spectrum (400 MHz, benzene-d₆, 23° C.) of ^{Me2}SB(^{iPr}N,I*)TiCl₂.

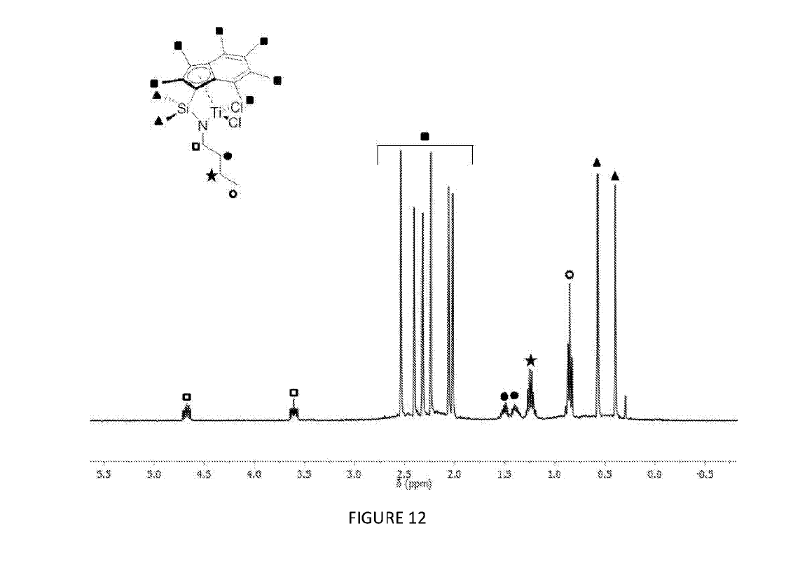

FIG. 12 shows the ¹H NMR spectrum (400 MHz, benzene-d₆, 23° C.) of ^{Me2}SB(^{nBu}N,I*)TiCl₂.

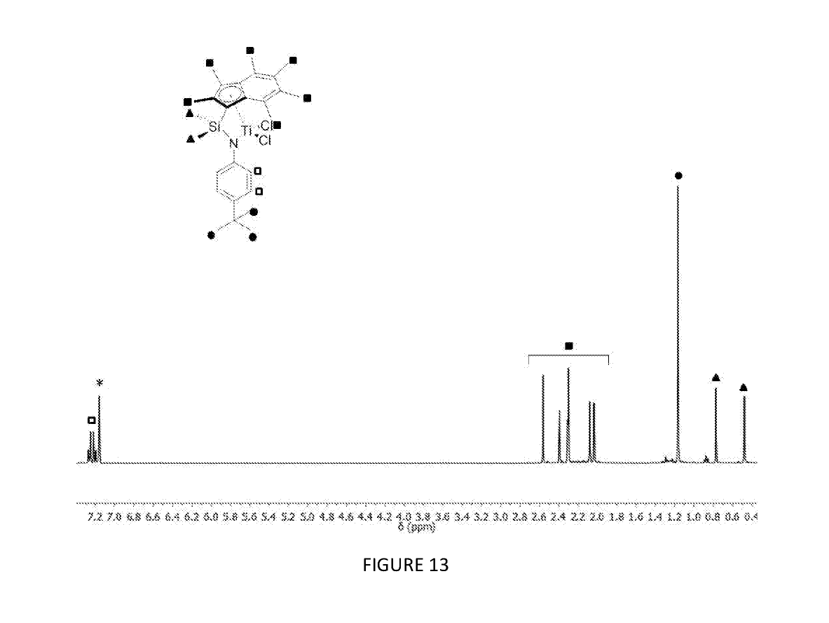

FIG. 13 shows the ¹H NMR spectrum (400 MHz, benzene-d₆, 23° C.) of ^{Me2}SB(^{4tBuPh}N,I*)TiCl₂.

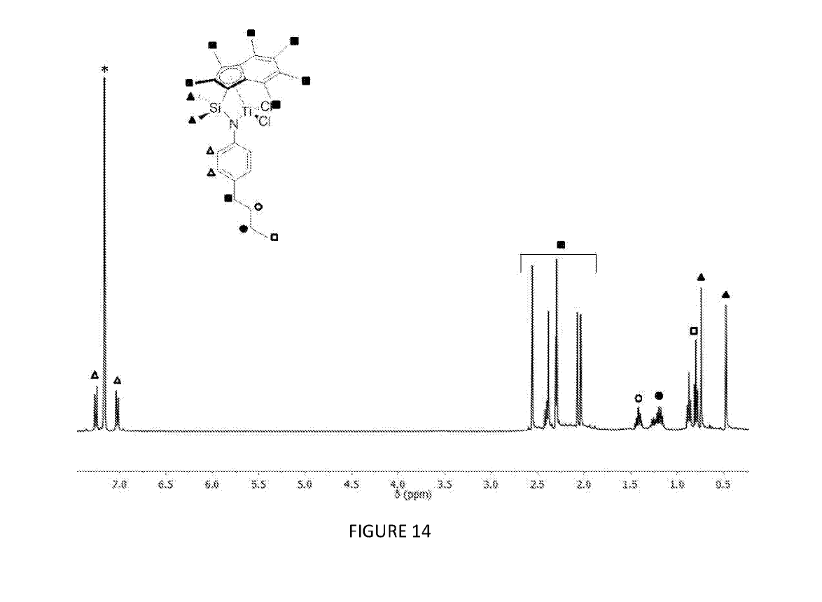

FIG. 14 shows the ¹H NMR spectrum (400 MHz, benzene-d₆, 23° C.) of ^{Me2}SB(^{4nBuPh}N,I*)TiCl₂.

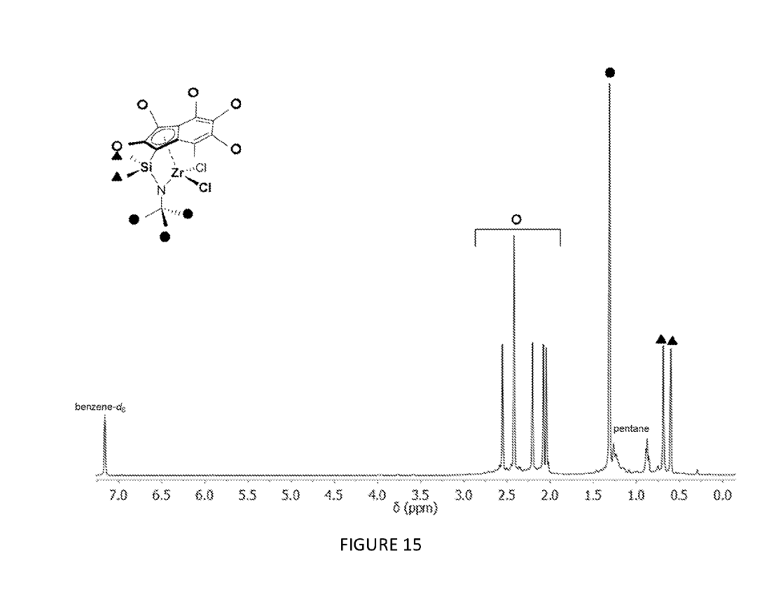

FIG. 15 shows the ¹H NMR spectrum (400 MHz, benzene-d₆, 23° C.) of ^{Me2}SB(^{tBu}N,I*)ZrCl₂.

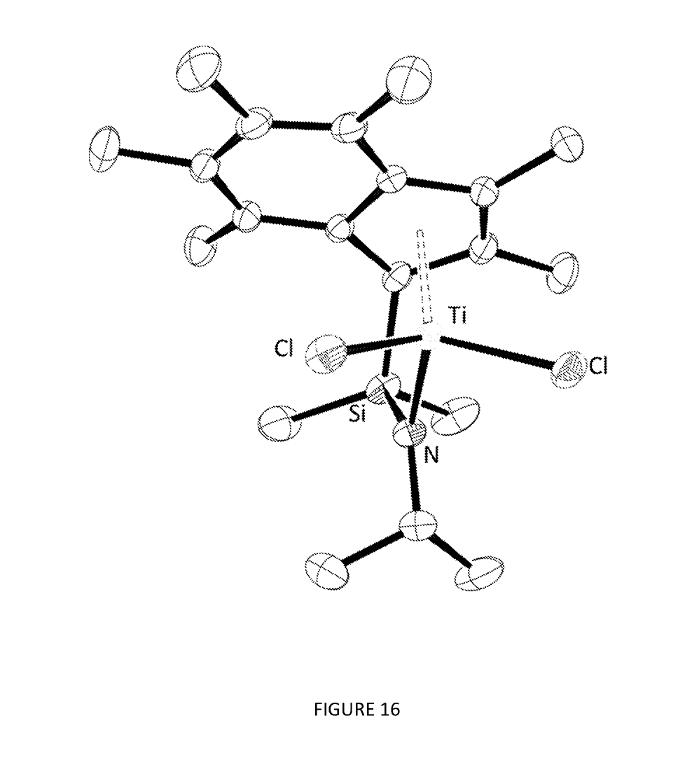

FIG. 16 shows the molecular structure of ^{Me2}SB(^{iPr}N,I*)TiCl₂.

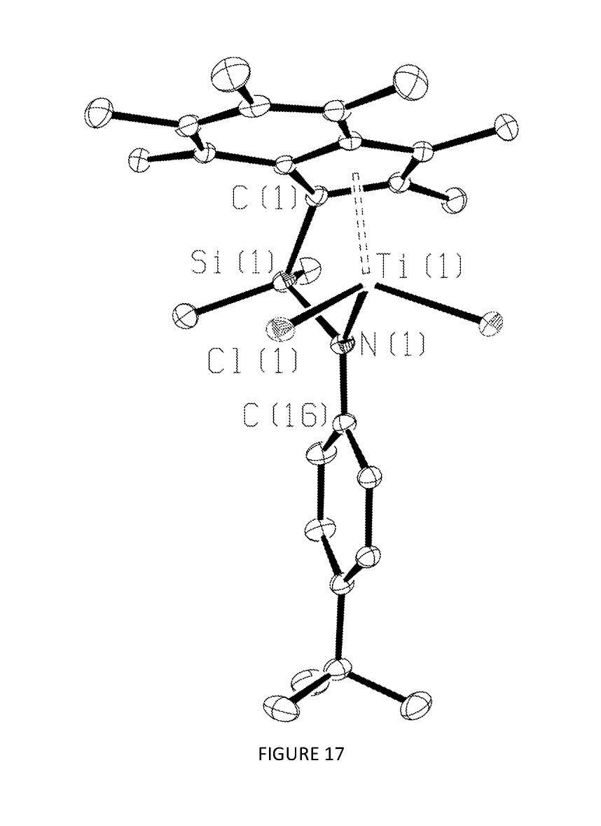

FIG. 17 shows the molecular structure of ^{Me2}SB(^{tBuPh}N,I*)TiCl₂.

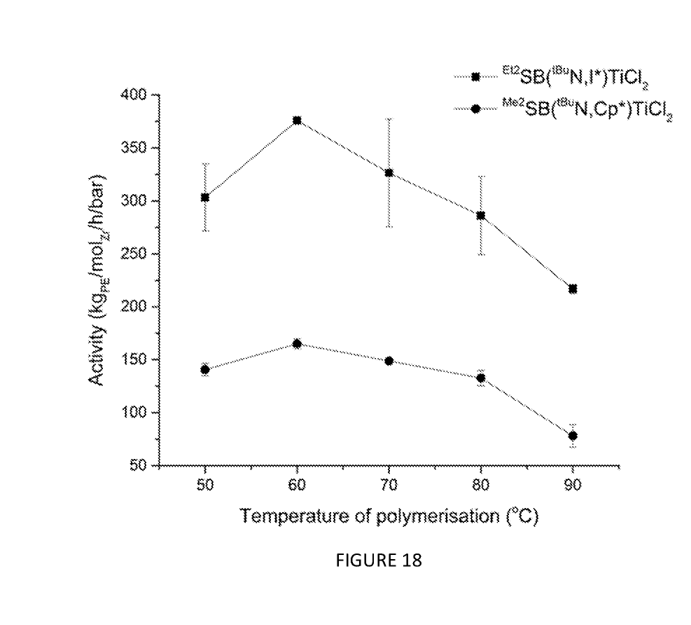

FIG. 18 compares the catalytic activity of the LDHMAO-^{Et}^{₂}SB(^{t}_{Bu}N,I*)TiCl₂ constrained geometry complex composition of the invention with that of the LDHMAO-^{Me}^{₂}SB(^{t}^{_{Bu}}N,Cp*)TiCl₂ comparator composition in the slurry phase polymerisation of ethylene. Polymerisation conditions: 2 bar ethylene, 50 mL hexanes, 150 mg TIBA, 70° C., 30 minutes.

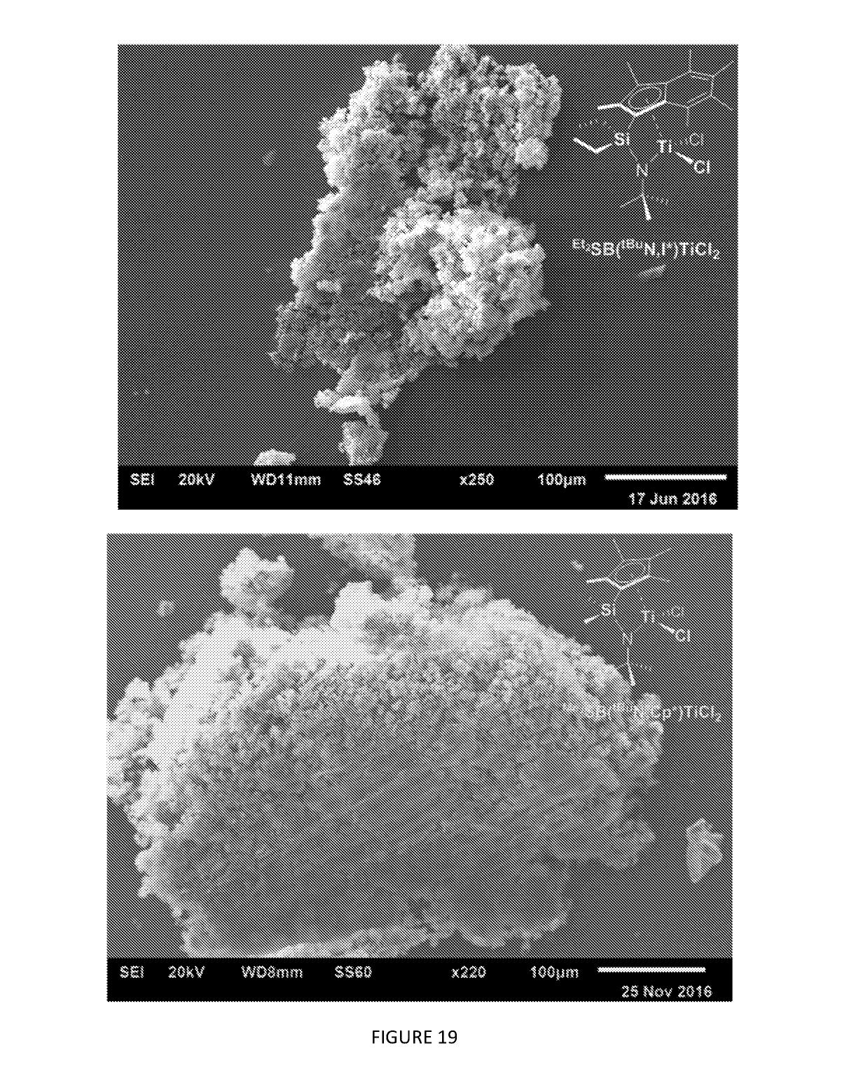

FIG. 19 shows the SEM images of polyethylene synthesised using the LDHMAO-^{Et}^{₂}SB(^{t}^{_{Bu}}N,I*)TiCl₂ constrained geometry complex composition of the invention and the LDHMAO-^{Me}^{₂}SB(^{t}^{_{Bu}}N,Cp*)TiCl₂ comparator composition in the slurry phase polymerisation of ethylene. Polymerisation conditions: 2 bar ethylene, 50 mL hexanes, 150 mg TIBA, 70° C., 30 minutes.

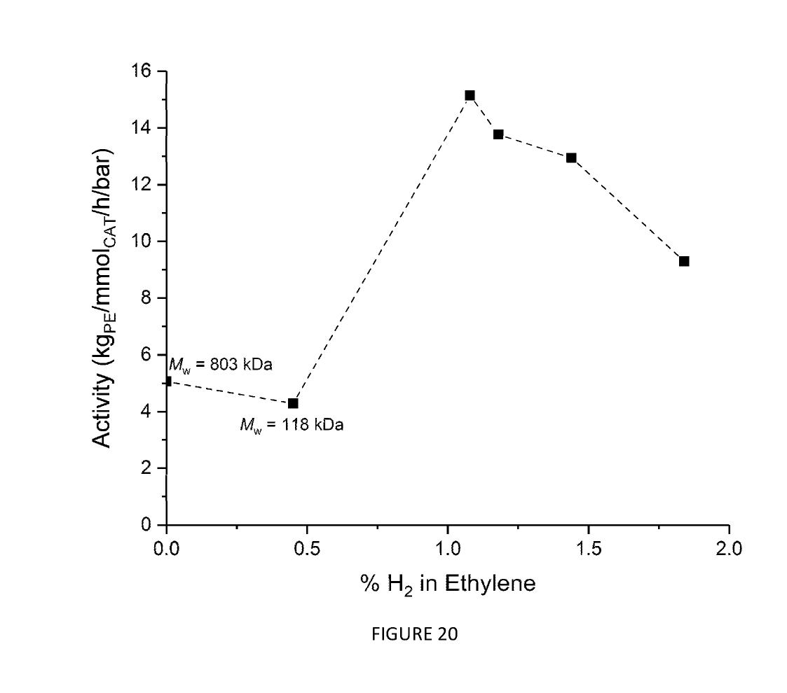

FIG. 20 shows scale up solution polymerisation of ethylene using ^{Me}^{₂}SB(^{t}^{_{Bu}}N,I*)TiCl₂. Polymerisation conditions: 5 bar ethylene, 1500 mL hexanes, 70° C., 30-60 minutes, 3-7 mg of ^{Me}^{₂}SB(^{t}^{_{Bu}}N,I*)TiCl₂.

### EXAMPLE 1

### Synthesis of silyl-briddedf(permethylindenyn(t-butyl amido)titanium dichloride (R²SB(^{tBu}N,I*)TiCl₂) CGCs

Having regard to Scheme 1 shown below, ligands useful in the preparation of the ^{R2}SB(^{tBu}N,I*)TiCl₂ CGCs were synthesised by the following procedure: In a large Schlenk, 1 equivalent of greenish oil hexamethylindene (Ind^{#})H (3.0 g, 15.0 mmol) was dissolved in 100 mL pentane to afford a greenish solution. 1.1 equivalent of ⁿBuLi (11.0 mL, 16.4 mmol, 2.5 M in Hexanes) was added dropwise (over 30 minutes) unto the previous solution cooled to 5° C. (ice/water bath). The solution turned slightly yellow/green. The reaction was left stirring at 23° C. for 18 h. After 18 h, the Schlenk contains off-white solid ((Ind^{#})Li) and dark orange solution. The pentane was pumped away to afford off-white solid. THF (30 mL) was added unto the solid to afford a red solution, then this solution was added dropwise (over 15 minutes) unto a previously cooled (to 5° C.) solution of 3.0 equivalent of dichlorodimethylsilane (5.8 g, 5.5 mL, 44.9 mmol) in THF (20 mL) or other dichlorodialkylsilane. The red solution of (Ind^{#})Li instantly decolourised when reacting with the previous solution. After 15 minutes, the yellow solution was stirred for 2 h at 23° C. Then, the THF was dried to afford Ind*SiMe₂Cl as an oil. Finally, 1.1 equivalent of LiNH^{t}Bu (1.3 g, 16.4 mmol) in THF (20 mL) was added at once unto a solution of Ind*SiMe₂Cl in THF (40 mL) cooled at to 5° C. (ice/water bath). The solution was stirred for 18 h, then dried, extracted with 2×20 mL of pentane and finally dried to afford ^{Me}^{₂}Si(^{t}^{_{Bu}}N,I*)H₂ as an oil in quantitative yield.

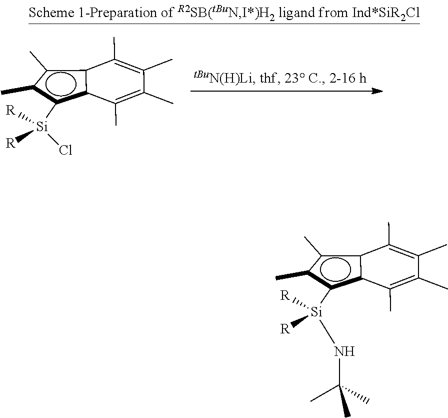

FIGS. 1 and 2 respectively show the ¹H NMR spectra for the ligands ^{Me2}SB(^{tBu}N,I*)H₂ and ^{Me,Propyl}SB(^{tBu}N,I*)H₂.

Once the ^{R2}SB(^{tBu}N,I*)H₂ ligand has been prepared, the ^{R2}SB(^{tBu}N,I*)TiCl₂ CGCs were formed according to Scheme 2 shown below by the following procedure: 2.2 equivalents of ⁿBuLi (2.7 mL, 6.7 mmol, 2.5 M in hexanes) was added dropwise, over 5 minutes, unto a solution of 1 equivalent of ^{Me}^{₂}Si(^{tBu}N,I*)H₂ (1 g, 3.0 mmol) in THF (40 mL) cooled to 5° C. The solution quickly turned red. The reaction was stirred for 2 h at 25° C. Then the solvent was dried and the sticky orange solid was washed with 2×50 mL of pentane to afford a yellow solid in quantitative yields. Benzene (40 mL) was added into a Schlenk containing 1 equivalent of ^{Me}^{₂}Si(^{tBu}N,I*)Li₂ (1 g, 2.9 mmol) and 1 equivalent of TiCl₄.THF₂ (978 mg, 2.9 mmol), the solution turned dark red. The reaction was stirred for 17 h at 25° C. Then, the solution was thoroughly dried and the dark red solid was extracted with 2×50 mL pentane. The pentane solution was concentrated to 20 mL and put in −30° C. freezer. A 1^{st} crop of ^{Me}^{₂}Si(^{tBu}N,I*)TiCl₂ was isolated in 26% yield (335 mg), the solution was put back in a −30° C. freezer.

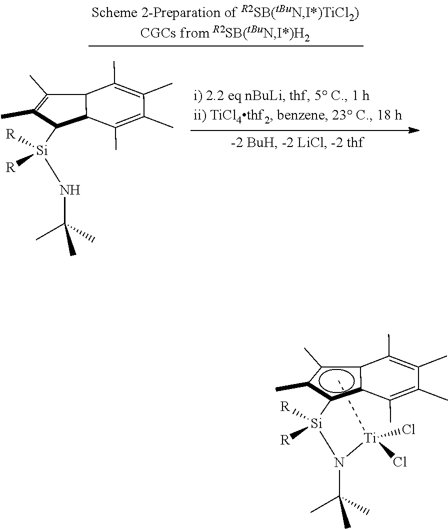

FIGS. 3 and 4 respectively show the ¹H NMR spectra for the CGCs ^{Me}^{₂}SB(^{tBu}N,I*)TiCl₂ and ^{Et2}SB(^{tBu}N,I*)TiCl₂. FIG. 5 shows the molecular structure of ^{Me2}SB(^{tBu}N,I*)TiCl₂.

### EXAMPLE 2

### Polymerisation Studies

### Ethylene Homopolymerisation

The catalytic activity of the ^{Et2}SB(^{tBu}N,I*)TiCl₂ compound of the invention in the solution-phase homopolymerisation of ethylene was compared with that of the commercially-available ansa-bridged permethylcyclopentadienyl amido CGC shown below:

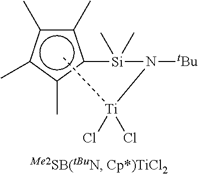

The results are provided in Table 1 below, as well as in FIG. 6.

TABLE 1
Solution phase polymerisation using unsymmetrical
I* (^{Et}^{₂}SB(^{t}^{_{Bu}}N,I*)TiCl₂) and commercial
constrained geometry complexes (^{Me}^{₂}SB(^{t}^{_{Bu}}N,Cp*)TiCl₂).

| | | Time | T | Yield | Activity |
|---|---|---|---|---|---|
| Complex | (μmol) | (s) | (° C.) | (mg) | (kg_{PE}/mol_{Ti}/h/bar) |
| ^{Et}^{₂}SB(^{t}^{_{Bu}}N,I*)TiCl₂ | 2.63 | 120 | 60 | 57 | 325 |
| ^{Et}^{₂}SB(^{t}^{_{Bu}}N,I*)TiCl₂ | 2.63 | 600 | 60 | 670 | 764 |
| ^{Me}^{₂}SB(^{t}^{_{Bu}}N,Cp*)TiCl₂ | 3.26 | 120 | 60 | 27 | 124 |
| ^{Me}^{₂}SB(^{t}^{_{Bu}}N,Cp*)TiCl₂ | 3.26 | 600 | 60 | 67 | 62 |

Polymerisation conditions: 2 bar ethylene, 50 mL hexanes, 40 mg MAO.

Table 1 and FIG. 6 show that the ^{Et2}SB(^{tBu}N,I*)TiCl₂ compound of the invention was more than twice as active as the ansa-bridged permethylcyclopentadienyl amido CGC currently favoured by industry over the course of a 120 second polymerisation reaction. Moreover, the ^{Et2}SB(^{tBu}N,I*)TiCl₂ compound of the invention was more than twelve times as active as the comparator compound when the duration of the polymerisation reaction was increased to 600 seconds.

### EXAMPLE 3

### Synthesis of dimethylsilyl-briddedf(permethylindenyl)(R amido)titanium dichloride (^{Me2}SB(^{R}N,I*)TiCl₂) CGCs

With regard to Scheme 3 shown below, ligands useful in the preparation of the ^{Me2}_{SB}(^{R}N,I*)TiCl₂ GCGs were synthesised by the following procedure: In a large Schlenk, 1 equivalent of greenish oil hexamethylindene (Ind^{#})H (3.0 g, 15.0 mmol) was dissolved in 100 mL pentane to afford a greenish solution. 1.1 equivalent of ⁿBuLi (11.0 mL, 16.4 mmol, 2.5 M in hexanes) was added dropwise (over 30 minutes) unto the previous solution cooled to 5° C. (ice/water bath). The solution turned slightly yellow/green. The reaction was left stirring at 23° C. for 18 h. After 18 h, the Schlenk contains off-white solid ((Ind^{#})Li) and dark orange solution. The pentane was pumped away to afford off-white solid. THF (30 mL) was added unto the solid to afford a red solution, then this solution was added dropwise (over 15 minutes) unto a previously cooled (to 5° C.) solution of 3.0 equivalent of dichlorodimethylsilane (5.8 g, 5.5 mL, 44.9 mmol) in THF (20 mL). The red solution of (Ind^{#})Li instantly decolourised when reacting with the previous solution. After 15 minutes, the yellow solution was stirred for 2 h at 23° C. Then, the THF was dried to afford Ind*SiMe₂Cl as an oil. 1 equivalent of RNHLi (R=ⁱPr (0.21 g), ⁿBu (0.27 g), 4-^{t}BuPh (0.50 g), and 4-ⁿBuPh (0.50 g)) and Ind*SiMe₂Cl (1.00 g, 3.40 mmol) were dissolved in THF (50 mL) cooled to 5° C. (ice/water bath). The solution was stirred for 2 h at 23° C., then dried, and the product extracted in 2×20 mL of pentane and dried to yield ^{Me2}SB(^{R}N,I*)H₂ as an oil in a quantitative yield.

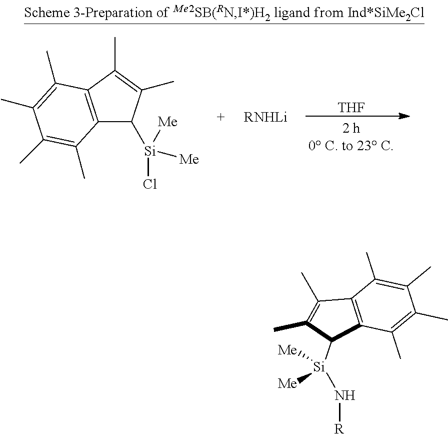

FIGS. 7, 8, 9 and 10 respectively show the ¹H NMR spectra for the ligands ^{Me2}SB(^{iPr}N,I*)H₂, ^{Me2}SB(^{nBu}N,I*)H₂, ^{Me2}SB(^{4tBuPh}N,I*)H₂ and ^{Me2}SB(^{4nBuPh}N,I*)H₂

Following the preparation of the proligand ^{Me2}SB(^{R}N,I*)H₂, the ^{Me2}SB(^{R}N,I*)TiCl₂ CGC was synthesised according to the procedure shown in Scheme 4: 2.2 equivalents of ⁿBuLi (3.0 mL, 6.7 mmol, 2.5 M in hexanes) was added dropwise to a solution of ^{Me2}SB(^{R}N,I*)H₂ in 30 mL of THF cooled to 5° C. (water/ice bath). The solution darkened from yellow to orange and the reaction mixture was stirred for 30 minutes at 23° C. The reaction mixture was then dried under vacuum, and the solid product was washed with pentane (2×25 mL) and dried to yield a yellow solid ^{Me2}SB(^{R}N,I*)Li₂. 40 mL of benzene was added to a Schlenk containing 1 equivalent of ^{Me2}SB(^{R}N,I*)Li₂ (R=iPr (0.35 g, 1.07 mmol), nBu (0.56 g, 1.65 mmol), 4-tBuPh (1.00 g, 2.40 mmol), 4-nBuPh (1.00 g, 2.40 mmol)) and 1 equivalent of TiCl₄.2THF (0.36 g, 0.55 g, 0.80 g, 0.80 g respectively). The solution turned a dark red and was stirred for 23 h. The reaction mixture was then dried under vacuum, and the product was extracted in pentane. The pentane solution was placed in a −30° C. freezer and a red solid was afforded in all cases. ^{Me2}SB(^{iPr}N,I*)TiCl₂ was isolated in a 5.3% yield (79 mg), ^{Me2}SB(^{nBu}N,I*)TiCl₂ in a 6.5% yield (102 mg), ^{Me2}SB(^{4-tBuPh}N,I*)TiCl₂ in a 28% yield (360 mg), and ^{Me2}SB(^{4-nBuPh}N,I*)TiCl₂ in a 21% yield (280 mg).

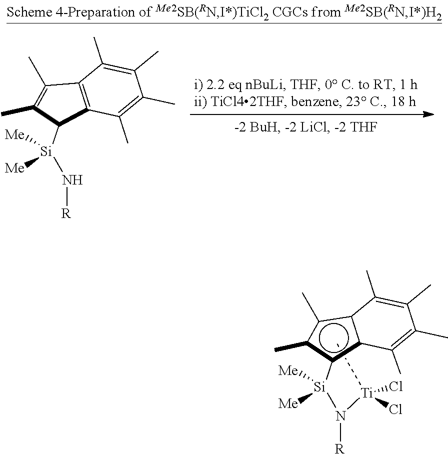

FIGS. 11, 12, 13, 14, and 15 respectively show the ¹H NMR spectra for the CGCs ^{Me2}SB(^{iPr}N,I*)TiCl₂, ^{Me2}SB(^{nBu}N,I*)TiCl₂, ^{Me2}SB(^{4tBuPh}N,I*)TiCl₂, ^{Me2}SB(^{4nBuPh}N,I*)TiCl₂ and ^{Me2}SB(^{tBu}N,I*)ZrCl₂. FIGS. 16 and 17 respectively show the molecular structures of ^{Me2}SB(^{iPr}N,I*)TiCl₂ and ^{Me2}SB(^{4tBuPh}N,I*)TiCl₂.

### EXAMPLE 4

### Synthesis of methylaluminoxane-activated layered double hydroxide-supported CGCs

Toluene was added to 1.0 equivalent LDH (Mg₃Al—CO₃) and 0.5 equivalents MAO in a Schlenk tube and the mixture heated at 80° C. for two hours with swirling. The white solid was allowed to settle, the solution decanted and the product dried under vacuum to give the activated supports in quantitative yield. LDHMAO (250 mg, 1.497 mmole) and ^{Et2}SB(^{tBu}N,I*)TiCl₂ (5.6 mg, 0.75 pmol) were weighed into a Schlenk tube, toluene (40 mL) was added and the solution swirled at 60° C. for one hour. The coloured solid was allowed to settle and the clear, colourless solution decanted. The solid was dried in vacuo to give the product as a faintly coloured powder in quantitative yield. Isolated yield of 86%.

### EXAMPLE 5

### Further Polymerisation Studies

### Slurry Phase Polymerisation

The ability of methylaluminoxane-activated layered double hydroxide-supported ^{Me2}SB(^{tBu}N,I*)TiCl₂ (denoted LDHMAO-^{Me2}SB(^{tBu}N,I*)TiCl₂) to catalyse the polymerisation of ethylene in the slurry phase was compared with that of the comparator methylaluminoxane-activated layered double hydroxide-supported ^{Me2}SB(^{tBu}N,Cp*)TiCl₂ composition (denoted LDHMAO-^{Me2}SB(^{tBu}N,Cp*)TiCl₂). The polymerisation conditions were 2 bar ethylene, 50 mL hexanes, 150 mg TIBA, 70° C., 30 minutes. FIG. 18 shows that the LDHMAO-^{Me2}SB(^{tBu}N,I*)TiCl₂ composition of the invention is markedly more active than the comparator LDHMAO-^{Me2}SB(^{tBu}N,Cp)TiCl₂ composition under identical polymerisation conditions. Moreover, FIG. 19 illustrates that the polyethylene obtained with the LDHMAO-^{Me2}SB(^{tBu}N,I*)TiCl₂ composition of the invention has an overall better morphology than the polyethylene obtained with the comparator LDHMAO-^{Me2}SB(^{tBu}N,Cp*)TiCl₂ composition.

### Scale-Up Solution Phase Polymerisation

The ability of the ^{Me2}SB(^{tBu}N,I*)TiCl₂ CGC of the invention to polymerise ethylene in the solution phase under scaled-up conditions was assessed. The polymerisation conditions were 5 bar ethylene, 1500 mL hexanes, 70° C., 30-60 minutes, 3-7 mg of ^{Me2}SB(^{tBu}N,I*)TiCl₂. The percentage of hydrogen in the ethylene feed stream was varied. FIG. 20 shows that ^{Me2}SB(^{tBu}N,I*)TiCl₂ exhibits very high activity in large scale solution phase ethylene polymerisation, in particular when the ethylene feed stream contains 1% H₂.

In a separate experiment, the ability of the ^{Me2}SB(^{tBu}N,I*)TiCl₂ CGC of the invention to copolymerise ethylene and 1-hexene under scaled-up conditions was assessed. The copolymerisation conditions were 6 bar ethylene, 1500 mL hexanes, 80° C., 34 minutes, 3.3 or 7 mg of ^{Me2}SB(^{tBu}N,I*)TiCl₂. The results are shown in Table 2 below. The ^{Me2}SB(^{tBu}N,I*)TiCl₂ CGC of the invention is seen to be active not only in ethylene homopolymerisation, but also in ethylene/1-hexene copolymerisation. The ^{Me2}SB(^{tBu}N, I*)TiCl₂ CGC showed a good copolymerisation response towards low polymer density (d=0.9189).

TABLE 2
Scale up solution copolymerisation of ethylene/1-hexene using^{Me}^{₂} SB(^{t}^{_{Bu}}N,I*)TiCl₂.
Copolymerisation conditions: 6 bar ethylene, 1500 mL hexanes, 80° C., 34 minutes, 3.3 or 7 mg
of^{Me}^{₂}SB(^{t}^{_{Bu}}N,I*)TiCl₂.

| | Quantity | Quantity | | | | | |
|---|---|---|---|---|---|---|---|
| | of | of 1- | | | | | |
| | complex | hexene | Time | T | Yield | Activity | |
| Complex | (mmol) | (mL) | (minutes) | (° C.) | (g) | (kg_{PE}/mol_{Ti}/h/bar) | Density |
| ^{Me}^{₂}SB(^{t}^{_{Bu}}N,I*)TiCl₂ | 0.016 | 28 | 34 | 80 | 90 | 1683 | 0.9189 |
| ^{Me}^{₂}SB(^{t}^{_{Bu}}N,I*)TiCl₂ | 0.007 | 42 | 34 | 80 | 140 | 5567 | 0.9327 |

While specific embodiments of the invention have been described herein for the purpose of reference and illustration, various modifications will be apparent to a person skilled in the art without departing from the scope of the invention as defined by the appended claims.

1. A compound of formula (I) shown below: 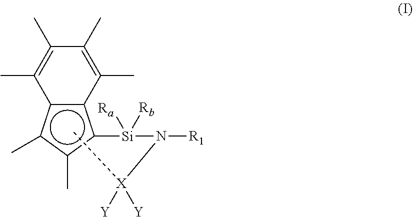
wherein
R₁ is (1-6C)alkyl, —Si(R₂)₃ or phenyl, either of which is optionally substituted with one or more groups selected from (1-4C)alkyl;
wherein each R₂ is independently selected from (1-3C)alkyl;
Rₐ and R_{b} are independently hydrogen, (1-6C)alkyl, aryl and aryl(1-2C)alkyl, either or which may be optionally substituted with one or groups selected from (1-2C)alkyl;
X is scandium, yttrium, lutetium, titanium, zirconium or hafnium
each Y is independently halo, hydrogen, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or Si[1-4C)alkyl]₃;
wherein Rₓ and R_{y} are independently (1-4C)alkyl.

2. The compound of claim 1, wherein R₁ is (1-5C)alkyl, —Si(R₂)₃ or phenyl, either of which is optionally substituted with one or more groups selected from (1-3C)alkyl, wherein each R₂ is independently selected from (1-4C)alkyl.

3. The compound of claim 1, wherein R₁ is (1-5C)alkyl, —Si(R₂)₃ or phenyl, either of which is optionally substituted with one or more groups selected from (1-3C)alkyl, wherein each R₂ is independently selected from (1-2C)alkyl.

4. The compound of claim 1, wherein R₁ is (2-5C)alkyl or phenyl, either of which is optionally substituted with one or more (e.g. 2 or 3) groups selected from (1-4C)alkyl.

5. The compound of claim 1, wherein R₁ is methyl, ethyl, iso-propyl, iso-butyl, n-butyl, sec-butyl, tert-butyl, neopentyl, trimethylsilyl, phenyl, mesityl, xylyl, di-isopropylphenyl, tert-butylphenyl or n-butylphenyl.

6.-9 (canceled)

10. The compound of claim 1, wherein Rₐ and R_{b} are independently selected from hydrogen, (1-4C)alkyl and phenyl.

11. (canceled)

12. (canceled)

13. The compound of claim 1, wherein X is titanium, zirconium or hafnium.

14. (canceled)

15. (canceled)

16. The compound of claim 1, wherein each Y is independently halo, hydrogen, or a (1-4C)alkyl group which is optionally substituted with one or more groups selected from (1-4C)alkyl, halo, nitro, amino, phenyl and (1-4C)alkoxy.

17. The compound of claim 1, wherein each Y is independently halo, hydrogen, or a (1-4C)alkyl group which is optionally substituted with one or more groups selected from (1-4C)alkyl, halo and phenyl.

18.-21. (canceled)

22. The compound of claim 1, wherein the compound of formula (I) has a structure according to formula (Ia) below: 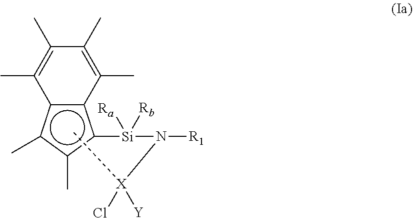
wherein Rₐ, R_{b}, X, Y and R₁ each have the definition of claim 1.

23. (canceled)

24. The compound of claim 1, wherein the compound of formula (I) has a structure according to formula (Ie) shown below: 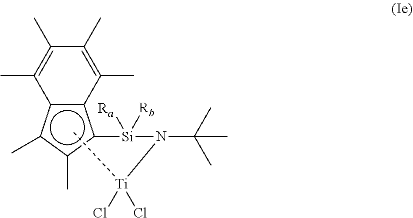
wherein
Rₐ and R_{b} are independently (1-3C)alkyl.

25. The compound of claim 1, wherein the compound of formula (I) has any of the following structures:

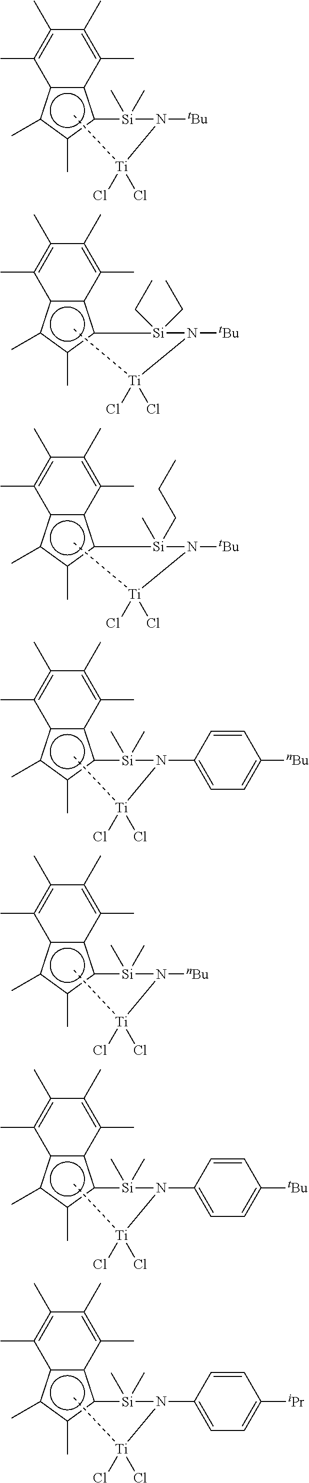

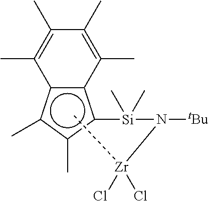

26. A composition comprising a compound of formula (I) as defined in claim 1 and:
i. a support material; and/or
ii. an activator.

27. The composition of claim 26, wherein the activator is an organo aluminium compound.

28. The composition of claim 26, wherein the support material is selected from silica, MAO-activated silica, layered-double hydroxide (LDH) and MAO-activated LDH.

29. The composition of claim 26, wherein the LDH is an AMO-LDH, wherein AMO denotes an aqueous miscible organic solvent, a quantity of which is contained within the LDH structure.

30. The composition of claim 26, wherein the activator is selected from methylaluminoxane, triisobutylaluminium, diethylaluminium and triethylaluminium.

31.-34. (canceled)

35. A polymerisation process comprising the step of:
a) polymerising ethylene and optionally one or more (3-10C)alkene in the presence of a compound of formula (I) as claimed in claim 1.

36. The process of claim 35, wherein step a) comprises polymerising ethylene and optionally one or more (3-10C)alkene in the presence of hydrogen.

37. The process of claim 35, wherein the one or more (3-10C)alkene is 1-hexene or styrene.

38. (canceled)
